(19) United States
(12) Patent Application Publication
(10) Pub. No.: US 2025/0299899 A1
(43) Pub. Date: Sep. 25, 2025

(54) FOUR BAR LINKAGE MECHANISM FOR CIRCUIT BREAKER TO ROTATE MOVABLE CONDUCTOR AND OPERATING HANDLE IN OPPOSITE DIRECTIONS

(71) Applicant: EATON INTELLIGENT POWER LIMITED, DUBLIN 4 (IE)

(72) Inventors: Sujit Subhash Patwardhan, Pune (IN); Shashank Bharat Kadam, Pune (IN); Sandip Nagtilak, Solapur (IN); Ravindra Kumar Soni, Jhunjhunu (IN); Suraj Shimpi, Nashik (IN)

(73) Assignee: EATON INTELLIGENT POWER LIMITED, DUBLIN 4 (IE)

(21) Appl. No.: 18/615,345

(22) Filed: Mar. 25, 2024

(51) Int. Cl. H01H 71/24; H01H 71/16; H01H 71/40

(52) U.S. Cl. CPC H01H 71/2472; H01H 71/40; H01H 71/16

(57) ABSTRACT

A multi-pole plug-on miniature circuit breaker includes a single operating mechanism. A four bar kinematic linkage used in the operating mechanism simplifies the manufacturing and assembly of the circuit breaker, and reduces the force needed to actuate the operating mechanism. The operating mechanism is operably coupled to the movable conductors of all poles such that the operating mechanism rotates all movable conductors simultaneously when the operating mechanism is actuated. The kinematic linkage is positioned between the lateral boundaries of only one of the pole assemblies, but the trip mechanisms of all of the pole assemblies are mechanically linked to one another, such that actuation of any one of the trip mechanisms actuates the operating mechanism. The operating mechanism is designed such that an operating handle connected to the operating mechanism rotates in a direction opposite the direction of rotation of the movable conductors.

### FIELD OF THE INVENTION

The disclosed concept relates generally to circuit breakers, and in particular, to systems that actuate the operating mechanism of a plug-on circuit breaker between its various states.

### BACKGROUND OF THE INVENTION

Circuit interrupters, such as for example and without limitation, circuit breakers, are typically used to protect electrical components and systems from damage caused by overcurrent conditions, such as and not limited to: overload conditions, short circuits, arc faults, and ground faults. Circuit breakers typically include mechanically separable contacts, an operating mechanism configured to operate the separable contacts as a switch, a trip mechanism configured to automatically actuate the operating mechanism during a fault condition, and an operating handle operably connected to the operating mechanism. The separable contacts are configured to be actuated between a closed state and an open state by the operating mechanism. In the closed state, the separable contacts are in physical and electrical contact with one another, enabling current to flow from the line side to the load side of the circuit breaker. In the open state, the separable contacts are physically separated and electrically isolated one another, so as to prevent the flow of current between the line side and the load side of the circuit breaker.

Under normal operating conditions, the operating handle enables a user to manually actuate the operating mechanism between the closed and open states. Under a fault condition, the trip mechanism automatically actuates the operating mechanism to open the separable contacts, and the operating handle is typically configured to move to a position unique to the trip state in order to indicate to the user that a trip has occurred. The separable contacts need to be opened as quickly as possible under a fault condition, but the interdependencies of the operating mechanism, the trip mechanism, and the operating handle can lead to mechanical complexity. The need to open the connection between the line side and the load side during a fault condition is heightened in a multi-pole circuit breaker. As a result, the number of components needed to actuate opening and closing of each pole's separable conducts under different operating conditions can become quite high, and the force needed to simultaneously open multiple poles in a circuit breaker can present an obstacle to being able to open the separable contacts as quickly as desired under fault conditions.

There is thus room for improvement in operating mechanisms of circuit breakers and in mechanical linkages therefor.

### SUMMARY OF THE INVENTION

These needs, and others, are met by a multi-pole circuit breaker that uses a single operating mechanism to simultaneously open the movable conductors of all of the poles. A four bar kinematic linkage used in the operating mechanism reduces the force needed to actuate the operating mechanism. The kinematic linkage is positioned between the lateral boundaries of only one of the pole assemblies, but the trip mechanisms of all of the pole assemblies are operably coupled to the kinematic linkage, such that any one trip mechanism can actuate the operating mechanism. The operating mechanism is designed such that an operating handle connected to the operating mechanism rotates in a direction opposite the direction of rotation of the movable conductors.

In accordance with one aspect of the disclosed concept, a circuit breaker comprises: a housing comprising an interior; a plurality of pole assemblies housed within the housing; an operating mechanism housed within the housing; and an operating handle operably coupled to the operating mechanism, the operating handle extending between the interior of the housing and an external environment. Each pole assembly includes: a stationary conductor comprising a stationary separable contact; a movable conductor comprising a movable separable contact, the movable conductor being structured to be actuated between a closed state and an open state in order to close and open an electrical connection between a corresponding load and a power source; a current sensor structured to sense current flowing in the pole assembly; and a trip mechanism coupled to the trip mechanism of every other pole assembly in the circuit breaker and structured to be actuated by the current sensor when current in the pole assembly exceeds a predetermined threshold. The operating mechanism is configured to be actuated by the trip mechanism of each pole assembly and is operably coupled to the movable conductor of each pole assembly, and is structured such that, when either of the operating handle or the movable conductor is actuated to rotate in one direction, the other of the movable conductor or the operating handle rotates in another direction opposite the one direction.

In accordance with another aspect of the disclosed concept, an operating arrangement is structured for use with a multi-pole circuit breaker having a plurality of pole assemblies, each pole assembly being structured to provide an electrical connection between a power source and a corresponding load and comprising a stationary conductor with a stationary separable contact and a movable conductor with a movable separable contact, each movable conductor being structured to be actuated between a closed state and an open state in order to close and open the corresponding electrical connection, and each pole assembly including a trip mechanism coupled to the trip mechanism of every other pole assembly in the circuit breaker and being structured to be actuated when current in the pole assembly exceeds a predetermined threshold. The operating arrangement includes an operating mechanism and an operating handle. The operating mechanism is configured to be actuated by the trip mechanism of each pole assembly and is structured to be operably coupled to the movable conductor of each pole assembly. The operating handle is operably coupled to the operating mechanism and is structured to be manually actuated. The operating mechanism is structured such that, when either of the operating handle or the movable conductor is actuated to rotate in one direction, the other of the movable conductor or the operating handle rotates in another direction opposite the one direction.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a two-pole circuit breaker in accordance with an example embodiment of the disclosed concept;

FIG. 2 is a partial isometric view of the exterior of the two-pole circuit breaker that is schematically depicted in FIG. 1;

FIG. 3A is a sectional view of the circuit breaker shown in FIG. 2 as denoted by the cutting line S-S in FIG. 2, showing the improved operating mechanism of the circuit breaker, and showing the circuit breaker in the ON state with its separable contacts closed, in accordance with an exemplary embodiment of the disclosed concept;

FIG. 3B is the same sectional view shown in FIG. 3A, showing an alternative spring arrangement compensating for contact wear relative to a spring arrangement shown in FIG. 3A, in accordance with another exemplary embodiment of the disclosed concept;

FIG. 4 shows the sectional view of the circuit breaker shown in FIG. 3A, showing the circuit breaker in the OFF state with its separable contacts open, in accordance with an exemplary embodiment of the disclosed concept;

FIG. 5 shows the sectional view of the circuit breaker shown in FIG. 3A, showing the circuit breaker in the TRIP state with its separable contacts open, in accordance with an exemplary embodiment of the disclosed concept;

FIG. 6 shows the sectional view of the circuit breaker shown in FIG. 3A, showing the circuit breaker in the TRIP FREE state with its separable contacts open and its external handle stuck in the ON position, in accordance with an exemplary embodiment of the disclosed concept;

FIG. 7 is a perspective view of the two-pole circuit breaker shown in FIGS. 2-6, depicting the housing as transparent so as to show how the improved operating mechanism is operably coupled to both pole assemblies, and showing the circuit breaker in the OFF state with its separable contacts closed, in accordance with an exemplary embodiment of the disclosed concept; and

FIG. 8 is an elevation view of the two-pole circuit breaker shown in FIG. 7 in the TRIP state, shown looking from the bottom of the circuit breaker toward the top of the circuit breaker, with the arc chutes removed in order to provide a better view of the components of the improved operating mechanism and both pole assemblies.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

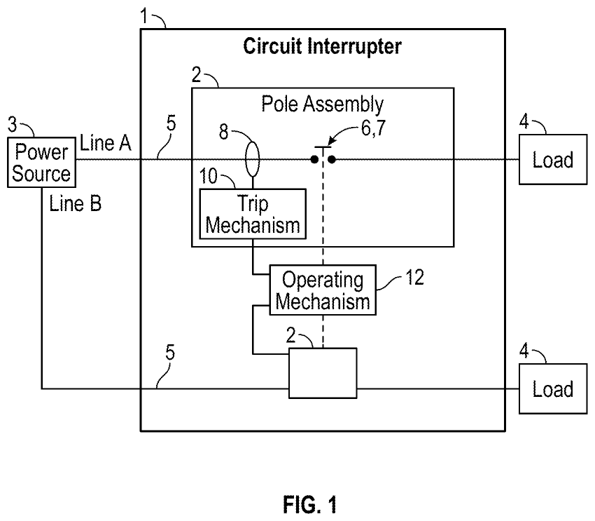

FIG. 1 is a schematic diagram of a circuit breaker 1, in accordance with an exemplary embodiment of the disclosed concept. The circuit breaker 1 includes a plurality of pole assemblies 2, with each pole assembly 2 being connected to a single phase of power. Specifically, two pole assemblies 2 are shown, but it will be apparent from the present disclosure that the concepts disclosed in relation to the pictured two-pole circuit breaker can be extended to a circuit breaker 1 having more than two pole assemblies 2 if desired. For ease of illustration, only the pole assembly 2 connected to line A is shown in detail in FIG. 1, however, it should be noted that the pole assembly 2 connected to line B includes components identical to the components included in the pole assembly 2 connected to line A and functions in the same manner as the pole assembly 2 connected to line A.

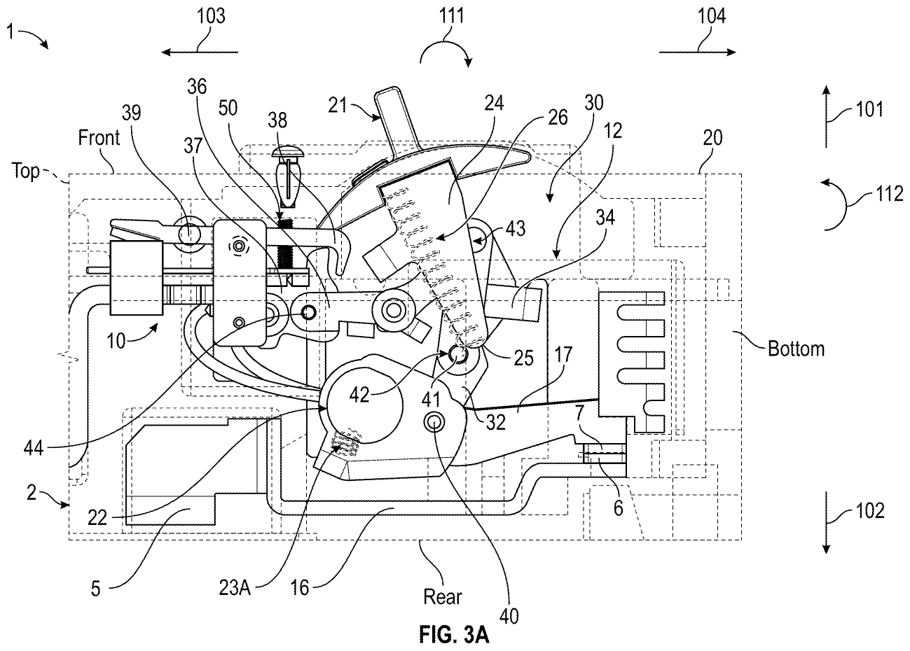

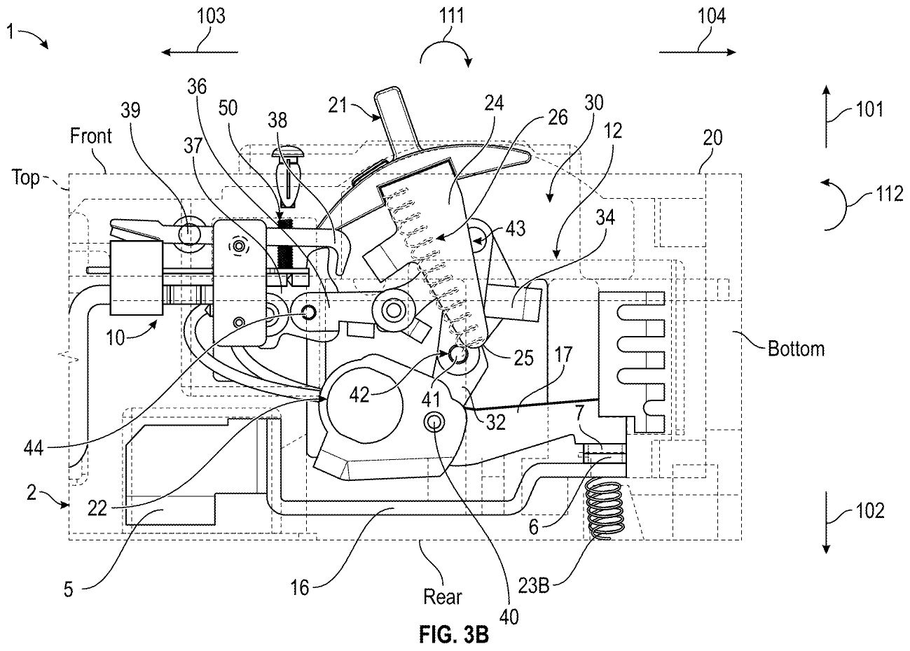

Each pole assembly 2 is structured to be electrically connected between a power source 3 and a load 4 via a line conductor 5, with each pole assembly 2 including a pair of mechanical separable contacts 6,7 structured to be actuated between a closed state (wherein the contacts 6,7 are in physical and electrical contact with one another) and an open state (wherein the contacts 6,7 are physically separated and electrically isolated from one another). The circuit breaker 1 is structured to trip open or switch open the separable contacts 6,7 in order to interrupt current flowing between the power source 3 and load 4 in the event of a fault condition (e.g., without limitation, an overcurrent condition) to protect the load 4 and any circuitry associated with the load 4, as well as the power source 3. It is noted that the separable nature of the separable contacts 6,7 is more apparent in the sectional views shown in FIGS. 3A-6.

Each pole assembly 2 further includes a current sensor 8 and a trip mechanism 10, and the circuit breaker 1 further includes an operating mechanism 12. Each current sensor 8 is operatively coupled to its corresponding trip mechanism 10, and each trip mechanism 10 is operatively coupled to the operating mechanism 12. In particular, each pole assembly 2 includes a bimetal strip and a magnetic trip mechanism, so that the bimetal strip can actuate tripping under sustained, lower magnitude overcurrent conditions and so that the magnetic trip mechanism can actuate tripping under acute, high overcurrent conditions such as short circuit conditions. As detailed further hereafter, each of the bimetal strip and the magnetic trip mechanism (and other associated components that are operatively coupled to the bimetal strip and the magnetic trip mechanism) can function as the current sensor 8 and trip mechanism 10. However, the current sensor 8 and the trip mechanism 10 as depicted in FIG. 1 are intended to be non-limiting and illustrative in nature, and the pole assemblies 2 can include current sensors and trip mechanisms other than the bimetal strips and magnetic trip mechanisms described herein without departing from the scope of the disclosed concept.

A bimetal strip comprises two different types of metals attached to one another and positioned in the current pathway. When a prolonged and relatively low magnitude overcurrent occurs, the metals of the bimetal strip begin to bend, with each metal bending at a different rate from the other metal, therefore causing the overall strip to bend. If the bending continues for long enough, the bending will cause the operating mechanism 12 to trip open the separable contacts 6,7 (for example and without limitation, the bending can cause the release of a latch that initiates actuation of the operating mechanism 12). Under such conditions, the bimetal strip functions as the current sensor 8, and the latch that gets released functions as the trip mechanism 10. A magnetic trip mechanism comprises a magnetizable core structured to be magnetized by current through the pole assembly 2, an armature in close proximity to the magnetizable core, and a trip actuating component (such as a lever) coupled to the armature. The structures and magnetic properties of the magnetizable core and armature are chosen such that the magnetic fields generated around the magnetizable core and armature will only be strong enough to actuate a trip when current through the pole assembly 2 reaches a fault level threshold. Specifically, when a high magnitude overcurrent event occurs, the magnetic fields generated around the magnetizable core and armature causes the armature to be pulled by the magnetizable core, thus actuating the trip actuating lever in a manner that causes the operating mechanism 12 to trip open the separable contacts 6,7. Under such conditions, the magnetizable core functions as the current sensor 8, and the armature and trip conductive arm function as the trip mechanism 10.

Regardless of the specific type of current sensor 8 and trip mechanism 10 employed in the pole assemblies 2, it should be understood that the current sensor 8 and trip mechanism 10 of each pole assembly 2 are configured to actuate the operating mechanism 12 when the power flowing through the pole assembly 2 reaches a level corresponding to a fault condition. The circuit breaker 1 is configured to enable the separable contacts 6,7 to be closed under normal operating conditions, so that current can flow from the power source 3 through the line conductor 5 and the mechanical contacts 6,7 to the load 4. In response to the current though either pole assembly 2 reaching a fault level (as detected by the current sensor 8), the trip mechanism 10 of the faulted pole assembly 2 actuates the operating mechanism 12 to simultaneously open the mechanical separable contacts 6,7 of both pole assemblies 2 in order to interrupt current flowing through the entire circuit breaker 1. The opening of the mechanical separable contacts 6,7 can be referred to as an “opening operation”. As labeled in FIGS. 3A-6 and as detailed further later herein, each pole assembly 2 further includes a stationary conductor 16 that comprises the separable contact 6 and a movable conductor 17 that comprises the separable contact 7. Each separable contact 6 is thus also referred to hereafter as the “stationary separable contact 6”, and each separable contact 7 is thus also referred to hereafter as the “movable separable contact 7”. An opening operation occurs when the operating mechanism 12 actuates rotation of both movable conductors 17 away from their corresponding stationary conductors 16. For each pair of separable contacts 6,7, the faster the contacts 6,7 separate and the greater the gap created between the contacts 6,7 is during an opening operation, the greater the arc length will be and the faster arc quenching will be completed.

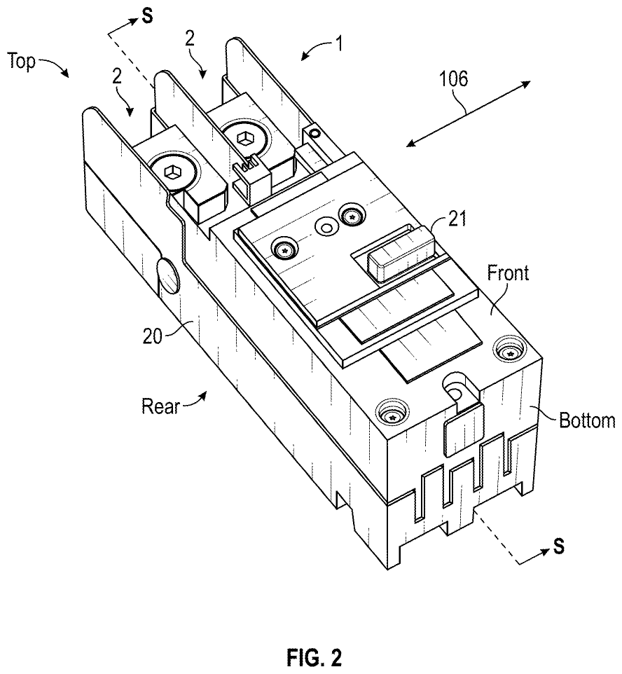

Reference is now briefly made to FIG. 2, which shows the exterior of the two-pole circuit breaker 1 schematically depicted in FIG. 1. As shown in FIG. 2, the circuit breaker 1 is specifically a plug-on type miniature circuit breaker, and is rated for 100 amps to 215 amps (100 A to 215 A). This is noted because the advantages of the operating mechanism 12 described hereinafter in connection with FIGS. 3A-8 are most fully realized in the design of a plug-on type miniature circuit breaker.

For ease of explanation, the orientations “front”, “back”, “top”, and “bottom” are labeled in FIG. 2 in order to denote which end of the circuit breaker 1 would typically be positioned at the top, which end of the circuit breaker 1 would typically be positioned at the bottom, which side of the circuit breaker 1 would be considered the front, and which side of the circuit breaker 1 would be considered the rear when the circuit breaker 1 is installed on an electric panel. These orientations are labeled in FIG. 2 and the subsequent figures solely to provide a consistent frame of reference for all of the views shown in the figures, and should not be construed as limiting on the specific orientation in which a user can install the circuit breaker 1 on an electrical panel. It should be noted that the top of the circuit breaker 1 shown in FIG. 2 is cut off in the views shown in FIGS. 3A-6.

In addition, the terms “frontward 101”, “rearward 102”, “upward 103”, and “downward 104” may be used herein to describe directions corresponding to the labeled orientations of “front”, “rear”, “top”, and “bottom” (arrows numbered with the reference numbers 101-104 are provided in FIGS. 3A-6). For example: “upward 103” movement denotes movement from the bottom to the top, “downward 104” movement denotes movement from the top to the bottom, “rearward 102” force denotes force exerted from front to rear, and “frontward 101” force denotes force exerted from rear to front. Furthermore, a dimension 106 is numbered in FIG. 2 to denote what is referred to hereafter as “lateral” orientation/movement, such that the reference number 106 can be used to describe moving “laterally”. For example, each pole assembly 2 of the circuit breaker 1 can be described as being disposed laterally 106 relative to the other pole assembly 2.

Continuing to refer to the orientation labels provided in the figures, it is noted that these orientations can be used to describe the sides or ends of the components included in the circuit breaker 1. For example, the side or end of a component that is closest to the front side of the circuit breaker 1 can be referred to as the “front side” or “front end” of the component. In another example, the side or end of a component that is closest to the bottom end of the circuit breaker 1 can be referred to as the “bottom side” or “bottom end” of the component.

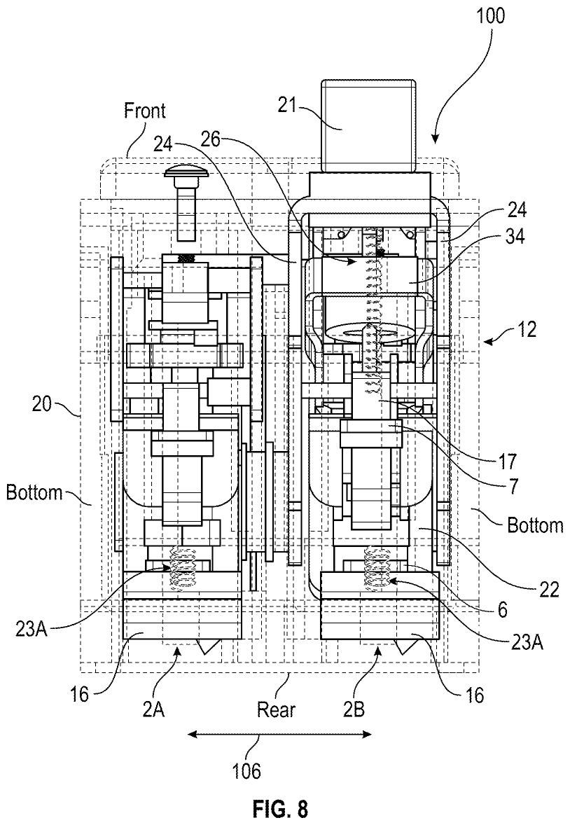

As shown in FIG. 2, the circuit breaker 1 comprises a housing 20 that houses the components of both pole assemblies 2, as well as an operating handle 21 that is operatively coupled to the operating mechanism 12 and extends from the interior of the housing 20 to the external environment, thus indicating to the user of the circuit breaker 1 what the state of the circuit breaker 1 is (e.g. ON, OFF, TRIP, TRIP FREE) and enabling the user to manually actuate the operating mechanism 12, as detailed further in connection with FIGS. 3A-6. The operating mechanism 12 and operating handle 21 can be collectively referred to as the operating arrangement 100, as numbered in FIG. 8.

As previously stated, the operating mechanism 12 is configured to actuate the separable contacts 6,7 of both pole assemblies 2 simultaneously. This is achieved by a drive shaft 22 (not visible in FIG. 2 but shown and numbered in FIGS. 3A-7) that is operably coupled to the movable conductors 17 of both pole assemblies 2 and to the operating mechanism 12. It will thus be appreciated that both pole assemblies 2 are always in the same state, and because the operating mechanism 12 is coupled to the operating handle 21, the operating handle 21 indicates the state of both pole assemblies 2 simultaneously. As previously stated, both pole assemblies 2 comprise identical components, and said components function in the same manner in both pole assemblies 2. If more than two pole assemblies 2 are included in the circuit breaker 1, the additional pole assemblies 2 will include components identical to the components of the two pole assemblies 2 shown in the figures, with the movable conductors 17 of the additional pole assemblies 2 also being operably coupled to the drive shaft 22 such that the additional pole assemblies 2 will always be in the same state as the two pole assemblies 2 shown.

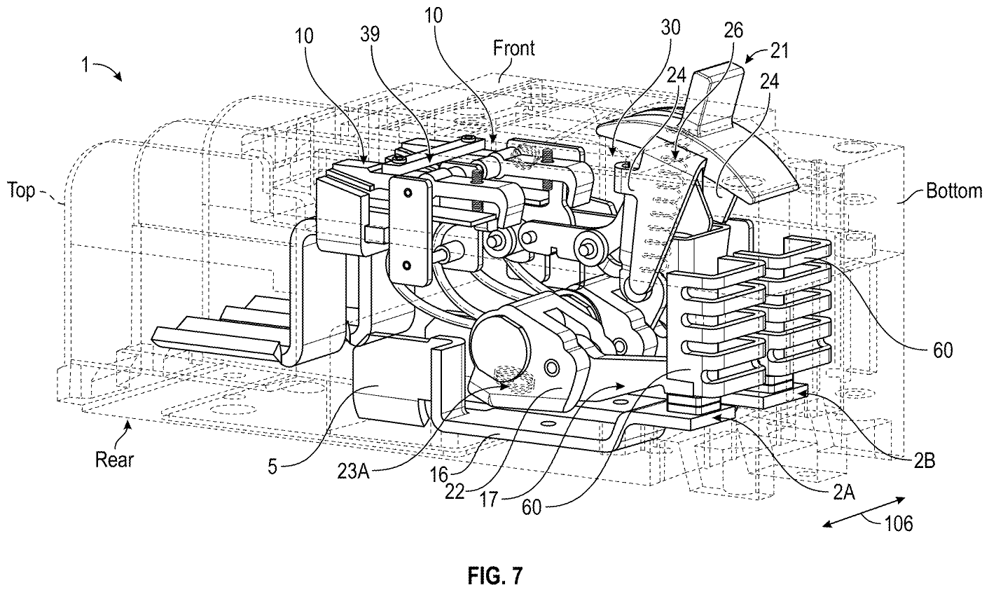

Reference is now made to FIGS. 3A-6, which are sectional views of the circuit breaker shown in FIGS. 1 and 2, as denoted by the cutting line S-S in FIG. 2. FIGS. 3A-6 show the operating mechanism 12 and one of the pole assemblies 2 in various states, in accordance with an exemplary embodiment of the disclosed concept. FIGS. 7-8 provide additional context for how the improved operating mechanism 12 is operably coupled to both pole assemblies 2 via the drive shaft 22. It is noted that each pole assembly 2 includes an arc chute 60, as numbered in FIG. 7, and that the arc chutes 60 are omitted from the illustration in FIG. 8 in order to better show the components of the operating mechanism 12 and both pole assemblies 2. In FIGS. 7-8, one pole assembly 2 is numbered with reference number 2A and the other pole assembly 2 is numbered with reference number 2B, in order to enable reference to a specific one of the pole assemblies 2 as needed, but the pole assemblies 2A and 2B can be referred to generally and individually or generally and collectively as the “pole assembly 2” or the “pole assemblies 2”.

While the sectional view shown in FIGS. 3A-6 only enables the pole assembly 2B to be visible (see FIGS. 7-8 for numbering of 2A and 2B), it should be understood that the non-visible pole assembly 2A is disposed in the same state as the visible pole assembly 2B, due to the pole assemblies 2 being positioned parallel relative to one another and due to the drive shaft 22 enabling the operating mechanism 12 to actuate the movable conductors 17 of both pole assemblies 2 simultaneously. It should also be understood that, if more than two pole assemblies 2 are included in the circuit breaker 1, all of the pole assemblies 2 will be operatively coupled to the drive shaft 22 and positioned parallel to one another in the same manner as the pole assemblies 2A and 2B.

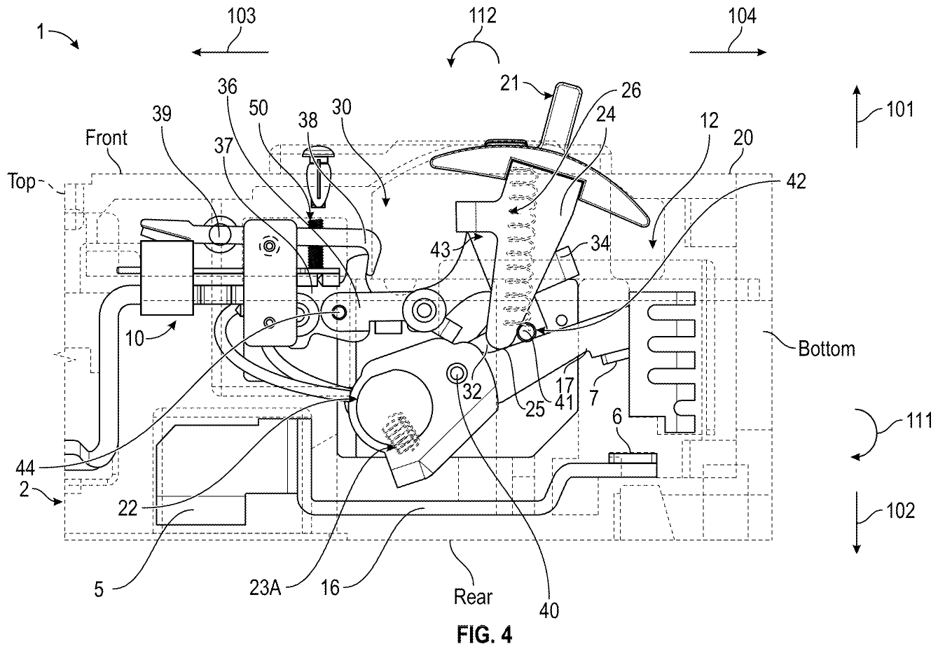

In FIG. 3A, the pole assembly 2 is in an ON state, such that the separable contacts 6,7 are closed, the operating mechanism 12 is in an ON state, and the operating handle 21 is in an ON position. The ON state of the pole assembly 2 in FIG. 3A indicates that operating conditions are normal within the circuit breaker 1, i.e. that current through both pole assemblies 2 is within the rated operating range of the circuit breaker 1. As previously stated, the stationary conductor 16 comprises the stationary separable contact 6, and the movable conductor 17 comprises the movable separable contact 7. The stationary conductor 16 is structured to remain fixed in position and is connected to the line conductor 5. The movable conductor 17 is structured to move between the closed state shown in FIG. 3A and the open state shown in FIGS. 4-6. Specifically, the operating mechanism 12 comprises a plurality of mechanical linkages (detailed further hereinafter) structured to actuate the movable conductor 17 between the closed state shown in FIG. 3A and the open state shown in FIGS. 4-6. Thus, it should be understood that opening of the separable contacts 6,7 occurs when the movable conductor 17 is actuated from its closed state to its open state and that closing of the separable contacts 6,7 occurs when the movable conductor 17 is actuated from its open state to its closed state.

FIG. 3B shows an embodiment of a spring arrangement that is provided in each pole assembly 2 as alternative to a spring arrangement shown in FIG. 3A, with said spring arrangement being included in each pole assembly 2 to compensate for wearing down of the separable contacts 6,7 that occurs over time due to arcing, among other factors. Specifically, the pole assembly 2 shown in FIG. 3A includes a drive shaft spring 23A, while the pole assembly 2 shown in FIG. 3B includes a line terminal spring 23B instead, the details of which are provided later herein. Aside from the difference in the springs 23A and 23B, the circuit breaker 1 as depicted in FIG. 3B is identical to the circuit breaker 1 as depicted in FIG. 3A and functions in the same manner. Hereinafter, when discussing attributes of the circuit breaker 1 in its ON state, reference will only be made to FIG. 3A for the sake of brevity, but it should be understood that such discussion applies to FIG. 3B as well, unless the drive shaft spring 23A is being discussed specifically.

Continuing to refer to FIG. 3A, as previously stated in connection with FIG. 2, the operating handle 21 indicates the state of the separable contacts 6,7 and of the operating mechanism 12 to the user of the circuit breaker 1. Specifically, the operating handle 21 being in the ON position shown in FIG. 3A indicates to the user that the separable contacts 6,7 are closed and that the operating mechanism 12 is in the ON state.

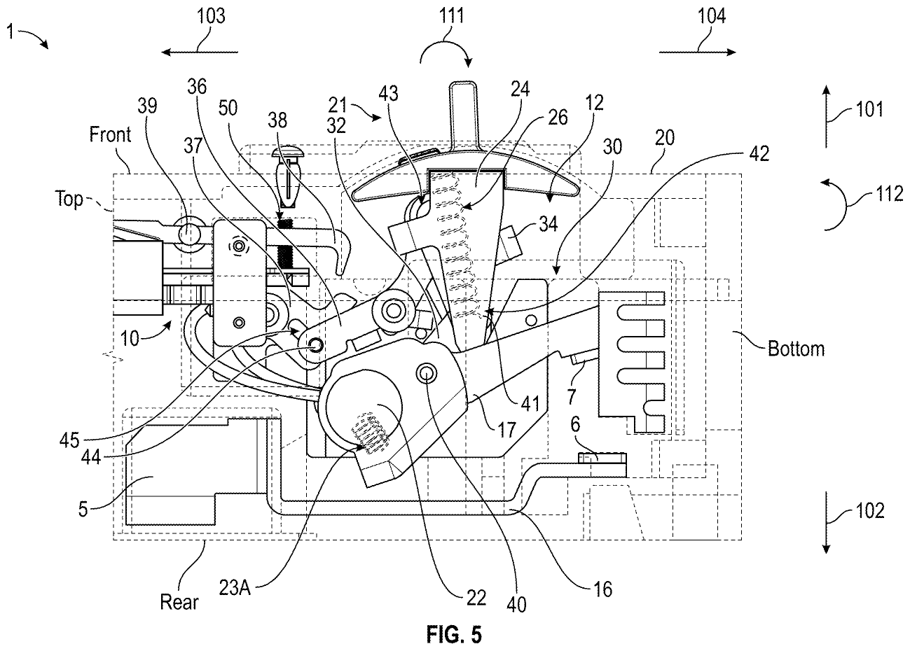

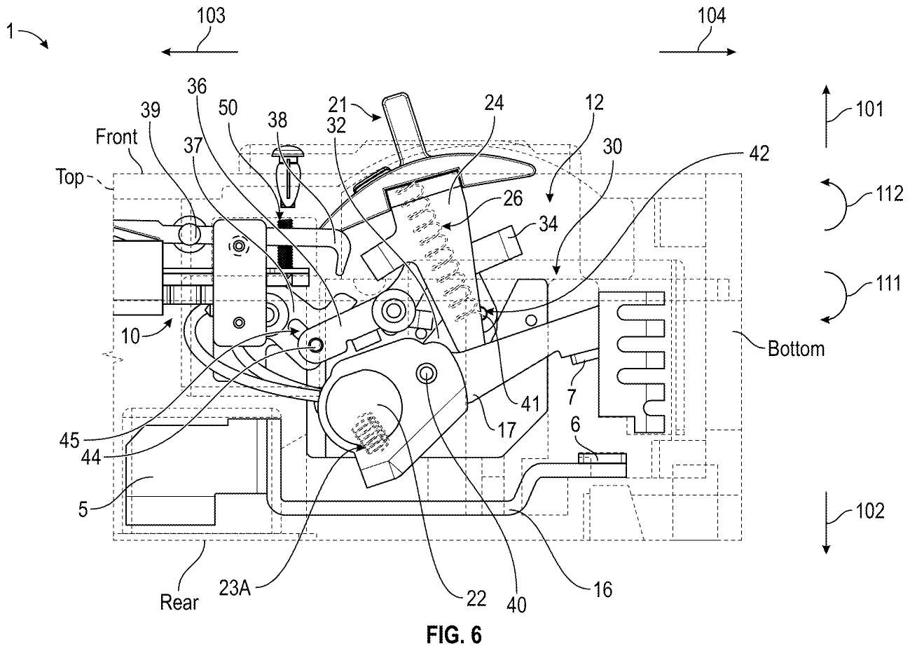

In FIG. 4, the circuit breaker 1 is in an OFF state, such that the separable contacts 6,7 are open, the operating mechanism 12 is in an OFF state, and the operating handle 21 is in an OFF position. The operating handle 21 being in the OFF position shown in FIG. 4 indicates to the user that the separable contacts 6,7 are open and that the operating mechanism 12 is in the OFF state. The OFF state of the circuit breaker 1 in FIG. 4 indicates that the circuit breaker 1 was manually turned off, i.e. that the user of the circuit breaker 1 actuated the operating handle 21 from one of the non-OFF positions (i.e. the ON position of FIG. 3A, the TRIP position of FIG. 5, or the TRIP-FREE position of FIG. 6) to the OFF position.

In FIG. 5, the circuit breaker 1 is in a TRIP state, such that the separable contacts 6,7 are open, the operating mechanism 12 is in a TRIP state, and the operating handle 21 is in a TRIP position. In viewing FIG. 5 in conjunction with FIGS. 3A and 4, it is noted that the TRIP position of the operating handle 21 shown in FIG. 5 is located between the “ON” and “OFF” positions shown in FIGS. 3A and 4. The operating handle 21 being in the TRIP position shown in FIG. 5 indicates to the user that the separable contacts 6,7 are open and that the operating mechanism 12 is in the TRIP state. More specifically, the TRIP state of the operating mechanism 12 in FIG. 5 indicates that the circuit breaker 1 was previously in the ON state (FIG. 3A) and that the operating mechanism 12 was actuated by one of the trip mechanisms 10 (FIG. 1) to trip open the separable contacts 6,7 of both pole assemblies 2 in order to interrupt current flow in the entire circuit breaker 1, due to the presence of a fault condition.

In FIG. 6, the circuit breaker 1 is in a TRIP FREE state, such that the separable contacts 6,7 are open, the operating mechanism 12 is in a TRIP state, and the operating handle 21 is in the ON position. It is noted that a trip free circuit breaker is a type of circuit breaker structured to enable opening of its separable contacts even when its manual on/off mechanism is stuck in the on state (e.g. the operating handle 21 being the manual on/off mechanism of the circuit breaker 1). The state of the circuit breaker 1 shown in FIG. 6 indicates that the operating handle 21 got stuck in the ON position during a fault condition but that the operating mechanism 12 was still successfully actuated by one of the trip mechanisms 10 (FIG. 1) to trip open the separable contacts 6,7 of both pole assemblies 2 in order to interrupt current flowing through the entire circuit breaker 1. It is noted that, although the operating handle 21 is in the ON position when the circuit breaker 1 is in the TRIP FREE state, a user of the circuit breaker 1 would understand that the circuit breaker 1 is in the TRIP FREE state rather than the ON state due to other indicators. For example and without limitation, the loads connected to the circuit breaker 1 would no longer be receiving power, and the circuit breaker 1 can include a visual indicator on the housing 20 (such as an LED that gets switched on/off due to a trip, for example and without limitation) that denotes that the circuit breaker 1 has been tripped. As discussed further hereafter, the TRIP FREE state shown in FIG. 6 is particularly demonstrative of the advantages of the design of the operating mechanism 12, as it is understood in the relevant field that an operating handle can become stuck due to any number of reasons, and that the circuit breaker still needs to be able to trip open in the event that the operating handle becomes stuck in the ON position when there is a fault condition in the circuit breaker.

As shown in FIGS. 3A-6, the operating handle 21 is fixedly coupled to two arms 24 that are parallel to one another (as best seen in FIG. 8) and that extend rearward 102 from the operating handle 21, with a surface 25 of each arm 24 being the rear-most surface of the arm 24 (surface 25 being visible in FIGS. 3A-4). The operating handle 21 is operatively coupled to the operating mechanism 12 via a toggle spring 26 as detailed further later herein. The details of how the operating handle 21 engages with the operating mechanism 12, including a kinematic linkage arrangement 30 of the operating mechanism 12, will now be discussed in detail with reference to FIGS. 3A-6, and with additional reference to FIGS. 7-8. As an initial matter, it is noted that the design of the operating mechanism 12 in the circuit breaker 1 provides an improvement to at least one known two-pole plug-on miniature circuit breaker. In the known plug-on miniature circuit breaker, each pole assembly requires its own operating mechanism such that two operating mechanisms are required to open both poles, and the two operating mechanisms use a kinematic linkage arrangement that includes a combined total of seven bar linkages. In contrast, the improved operating mechanism 12 of the circuit breaker 1 disclosed herein is structured to simultaneously open both pole assemblies 2 such that only a single operating mechanism 12 is required to open both pole assemblies 2, and the kinematic linkage arrangement 30 of the operating mechanism 12 comprises only four bar linkages. The disclosed operating mechanism 12 is thus simpler to maintain and requires significantly less assembly time than the operating mechanism of the known plug-on miniature circuit breaker, and also leads to the overall circuit breaker 1 having a 15% reduction in the number of parts compared to its predecessor, among other advantages which will become apparent later herein.

As previously noted, the circuit breaker 1 includes a drive shaft 22 that is operatively and fixedly coupled to the movable conductors 17 of both pole assemblies 2, and the operating mechanism 12 comprises a kinematic linkage arrangement 30 that is operatively coupled to the drive shaft 22. As shown in FIGS. 7-8, operating mechanism 12 is structured such that, relative to the lateral dimension 106, the kinematic linkage 30 arrangement and the operating handle 21 coincide with only one pole assembly 2 (i.e. the pole assembly 2B), and such that the kinematic linkage arrangement 30 and the operating handle 21 are disposed entirely laterally 106 relative to the other pole assembly 2 (i.e. the pole assembly 2A). It should be understood that, if more than two pole assemblies 2 are included in the circuit breaker 1 (i.e. such that one or more additional pole assemblies 2 are positioned laterally 106 relative to the pole assemblies 2A and 2B), then the kinematic linkage 30 arrangement and the operating handle 21 will also be disposed entirely laterally 106 relative to the additional pole assemblies 2 as well.

As better seen in FIGS. 3A-6, the kinematic linkage arrangement 30 comprises a first toggle link 32 that is directly and rotatably coupled to the drive shaft 22, a second toggle link 34 that is directly and rotatably coupled to the first toggle link 32, a trip link 36 that is directly and rotatably coupled to the second toggle link 34, and a latch link 37 that is directly and slidably coupled to the trip link 36. In FIGS. 3A-6, the trip mechanism 10 of the one pole assembly 2 is shown, while the trip mechanisms 10 of both pole assemblies 2 are shown in FIG. 7, and it is noted that they are magnetic trip mechanisms, each comprising a latch lever 38 structured to be actuated to rotate by an armature and a magnetic core (not numbered) when current through the corresponding pole assembly 2 reaches a fault level threshold. The latch lever 38 of each pole assembly's trip mechanism 10 is mechanically linked to the latch lever 38 of the other pole assembly's trip mechanism 10 by a dowel 39, which causes both pole assemblies' latch levers 38 to rotate simultaneously when either latch lever 38 is actuated to rotate by its corresponding armature. The operating mechanism 12 is structured such that the latch link 37 can only engage the latch lever 38 of the pole assembly 2B with which the operating mechanism 12 coincides (said latch lever 38 of the pole assembly 2B sometimes being referred to hereafter as the “link engaging latch lever 38”, to denote that it is the only latch lever 38 that can engage the latch link 37). However, because both latch levers 38 are mechanically linked together by the dowel 39 such that movement of one latch lever 38 causes simultaneous movement of the other latch lever 38, the operating mechanism 12 is configured to be actuated by the latch levers 38 of both trip mechanisms 10.

When current though both pole assemblies 2 is in the normal operating range, the latch levers 38 are disposed in an unactuated state. The latch levers 38 are depicted in the unactuated state in the figures. The operating mechanism 12 is structured and positioned to ensure that, when the circuit breaker 1 is in the ON and OFF states (FIGS. 3A and 4), the operating mechanism's latch link 37 engages the link engaging latch lever 38. It is noted that, when the latch levers 38 are in the unactuated state, they remain stationary relative to the circuit breaker housing 20, such that, when the latch link 37 is engaged with the link engaging latch lever 38 and current in all pole assemblies 2 is within the normal operating range, the latch link 37 and the trip link 36 also remain stationary relative to the housing 20 when the operating handle 21 is used to manually actuate the operating mechanism 12 between the ON and OFF states.

Regarding the rotatable coupling between the drive shaft 22 and the first toggle link 32 (as best seen in FIGS. 3A-4), a rotating pin 40 couples the drive shaft 22 and the first toggle link 32 to one another such that the drive shaft 22 and the first toggle link 32 are able to rotate about the rotating pin 40. Regarding the rotatable coupling between the first toggle link 32 and the second toggle link 34 (as best seen in FIGS. 3A-3B), a rotating pin 41 couples the first toggle link 32 and the second toggle link 34 to one another at a knee joint 42 such that both toggle links 32, 34 are able to rotate about the rotating pin 41. The rotating pin 41 is referred to hereinafter as the “knee joint rotating pin 41”. The trip link 36 and second toggle link 34 are similarly coupled to one another with a trip-toggle rotating pin 43 (as best indicated in FIGS. 3A-3B) such that they can both rotate about the trip-toggle rotating pin 43. Regarding the slidable coupling between the trip link 36 and the latch link 37, one end of a sliding pin 44 is fixedly coupled to the trip link 36 while a second end of the sliding pin 44 is received within a pin receiving slot 45 of the latch link 37 (the pin receiving slot 45 only being visible in FIGS. 5 and 6), which enables the trip link 36 to slide relative to the latch link 37 as the operating mechanism 12 moves from certain configurations to certain other configurations. One end of the toggle spring 26 is fixedly coupled to the operating handle 21 and the other end of the toggle spring 26 is fixedly coupled to the knee joint rotating pin 41, and relative to the lateral dimension 106, the toggle spring 26 is positioned between the two arms 24 (see FIG. 8). Seeing the disposition of the toggle spring 26 in each of the states of the operating mechanism 12 is helpful for understanding how the operating mechanism 12 functions, so the toggle spring 26 is shown in FIGS. 3A-8 in dashed line, as other components in FIGS. 3A-8 would actually obstruct the view of the toggle spring 26 in the views shown in the figures. The first toggle link 32, the second toggle link 34, and the toggle spring 26 are all configured to ensure that the toggle action of the operating handle 21 remains centered relative to the knee joint 42.

One of the advantages of the disclosed improved operating mechanism 12 is that the kinematic linkage arrangement 30 is configured to cause the movable conductor 17 to rotate in opposition to the direction of rotation of the operating handle 21, which can be discerned when comparing the ON state shown in FIG. 3A to the OFF state shown in FIG. 4. It is noted that references to directions of rotation (i.e. clockwise 111 and counterclockwise 112) discussed hereinafter reflect the directions relative to the views shown in the figures. In order to switch the circuit breaker 1 from the ON state (FIG. 3A) to the OFF state (FIG. 4), the operating handle 21 must be rotated clockwise 111 from the ON position (FIG. 3A) in order to reach the OFF position (FIG. 4), and it can be seen that the movable conductor 17 rotates counterclockwise 112 (i.e. in opposition to the clockwise 111 rotation of the operating handle 21) when rotating from the closed state (FIG. 3A) to the open state (FIG. 4). Conversely, in order to switch the circuit breaker 1 from the OFF state (FIG. 4) to the ON state (FIG. 3A), the operating handle 21 must be rotated counterclockwise 112 from the OFF position (FIG. 4) in order to reach the ON position (FIG. 3A), and it can be seen that the movable conductor 17 rotates clockwise 111 (i.e. in opposition to the counterclockwise 112 rotation of the operating handle 21) when rotating from the open state (FIG. 4) to the closed state (FIG. 3A). That is, clockwise 111 rotation of the operating handle 21 actuates counterclockwise 112 rotation of the movable conductor 17 and counterclockwise 112 rotation of the operating handle 21 actuates clockwise 111 rotation of the movable conductor 17.

The circuit breaker 1 is structured such that the operating mechanism 12 can only be manually actuated between the ON and OFF states (FIGS. 3A and 4) by manual actuation of the operating handle 21. In comparing the disposition of the operating mechanism 12 in FIGS. 3A and 4, it should be noted that the trip link 36 and the latch link 37 are disposed in the same position in both the ON state of FIG. 3A and the OFF state of FIG. 4 (said position being referred to hereafter as the “latched position”, due to the latch link 37 engaging the latch lever 38), because actuation of the operating mechanism 12 between its ON and OFF states is achieved without actuation of the trip link 36 and the latch link 37. The latched position is one in which the sliding pin 44 (which couples the trip link 36 to the latch link 37) is disposed at the top end of the pin receiving slot 45 (the pin receiving slot 45 only being visible in FIGS. 5-6). In contrast, when the trip link 36 and the latch link 37 are in an unlatched position, which only occurs in the TRIP state of FIG. 5 or the TRIP FREE state of FIG. 6, the sliding pin 44 is disposed at the bottom end of the pin receiving slot 45, as shown in FIGS. 5-6.

When the trip link 36 and the latch link 37 are in the latched position shown in FIGS. 3A and 4, the kinematic linkage arrangement 30 is disposed such that at least some portion of the knee joint rotating pin 41 is positioned as far rearward 102 as the rear-most surface 25 of each of the arms 24. When the operating handle 21 is in the ON state of FIG. 3A, the rear-most surface 25 of each arm 24 is disposed downward 104 of the knee joint rotating pin 41, and when the operating handle 21 is in the OFF state of FIG. 4, the rear-most surface 25 of each arm 24 is disposed upward 103 of the knee joint rotating pin 41. The components of the kinematic linkage arrangement 30 are configured such that, when the operating handle 21 is rotated and thus rotates the arms 24, the pulling force exerted on the front end of the toggle spring 26 by the operating handle 21 causes the toggle spring 26 to actuate rotation of the knee joint rotating pin 41. The rotation of the knee joint rotating pin 41 then actuates rotation of the second toggle link 34 and the first toggle link 32.

Still referring to the rotation of the operating handle 21 between the ON and OFF states of FIGS. 3A and 4, it is noted that the second toggle link 34 rotates in opposition to the direction of rotation of the arms 24. The rotation of the second toggle link 34 causes rotation of the first toggle link 32 in opposition to the direction of rotation of the second toggle link 34. The rotation of the first toggle link 32 causes rotation of the drive shaft 22 in opposition to the direction of rotation of the first toggle link 32, and the rotation of the drive shaft 22 causes rotation of the movable conductors 17 in both pole assemblies 2. The movable conductors 17 rotate in the same direction as the drive shaft 22.

As previously noted, to compensate for wearing down of the separable contacts 6,7 that occurs over time, either a drive shaft spring 23A (FIG. 3A) or a line terminal spring 23B (FIG. 3B) can be included in each pole assembly 2. Referring first to FIG. 3A, each drive shaft spring 23A is positioned within the interior of the drive shaft 22 in a manner that causes it to exert rearward 102 force on the movable conductor 17 of its corresponding pole assembly 2, in order to cause the movable conductor 17 of said pole assembly 2 to exert rearward 102 force on the corresponding stationary conductor 16 when the operating mechanism 12 is in the ON state, so that that the movable contact 7 maintains maximum physical contact with the stationary contact 6. The drive shaft spring 23A is shown in dashed line, as it would not be visible in the views shown in the figures. Referring now to FIG. 3B, one end of each line conductor spring 23B is coupled to the interior side of the rear wall of the housing 20 and the other end of the line conductor spring 23B is coupled to the rear side of the stationary conductor 16 of the corresponding pole assembly 2, in order to cause the stationary conductor 16 of said pole assembly 2 to exert frontward 101 force on the corresponding movable conductor 17 when the operating mechanism 12 is in the ON state, so that the stationary contact 6 maintains maximum possible physical contact with the movable contact 7 (it will be appreciated that, although stationary, the stationary conductor 16 has at least some degree of flexibility, which is why the line conductor spring 23B increases the contact force between the stationary contact 6 and the movable contact 7 when the separable contacts 6,7 are closed). It will be appreciated that, in the absence of the drive shaft springs 23A or of the line conductor springs 23B, when the separable contacts 6,7 have worn down, the surface area of each separable contact 6,7 cannot engage the surface area of the other separable contact 7,6 as fully.

Referring now to FIG. 3A (the ON state) in conjunction with FIG. 5 (the TRIP state), the mechanics of the kinematic linkage arrangement 30 that cause actuation of the operating mechanism 12 from the ON state to the TRIP state will now be detailed. As previously stated, the operating mechanism 12 is structured to maintain engagement between the latch link 37 and the latch lever 38 when the circuit breaker is in the ON and OFF states (FIGS. 3A-4), and the trip mechanisms 10 are configured to only actuate rotation of the latch levers 38 under a fault condition. When a fault condition is detected in either pole assembly 2, the trip mechanism 10 of the faulted pole is configured to actuate the latch lever 38 to rotate counterclockwise 112 (said rotation being actuated due to the magnetic field of the magnetizable core and armature magnetized by the fault current). When the latch lever 38 rotates a sufficient distance away from the latch link 37, the latch link 37 is free to move rearward 102 while rotating clockwise 111, and the sliding pin 44 that couples the trip link 36 to the latch link 37 is able to slide within the pin receiving slot 45 (FIG. 5) of the latch link 37 such that the trip link 36 slides from the top end of the pin receiving slot 45 to the bottom end of the pin receiving slot 45. The sliding of the trip link 36 causes the linkage formed by the trip link 36 and the latch link 37 to move far enough rearward 102 such that the latch link 37 cannot re-engage the latch lever 38 when the latch lever 38 subsequently rotates clockwise 111 back to its unactuated state (which occurs after the separable contacts 6,7 have opened and the current is interrupted, since the interruption of the current causes the magnetic field of the magnetizable core and armature to dissipate). The latch link 37 and the trip link 36 are said to be in the unlatched position (as shown in FIG. 5) when this happens.

Continuing to refer to FIG. 3A (the ON state) in conjunction with FIG. 5 (the TRIP state), as previously stated, the latch link 37 and the trip link 36 are in the latched position when the operating mechanism 12 is in the ON state (FIG. 3), and it is noted that the toggle spring 26 is expanded from its default state when the latch link 37 and the trip link 36 are in the latched position. Once the latch link 37 and the trip link 36 are unlatched (FIG. 5), the toggle spring 26 compresses toward its default state, since the latching force between the latch link 37 and the latch lever 38 that previously kept the toggle spring 26 expanded is no longer present. The difference between the expansion and compression of the toggle spring 26 may not be discernible in the figures. The compression of the toggle spring 26 to its default state causes the knee joint 42 to move forward 101, such that the joint between the trip link 36 and the second toggle link 34 formed by the trip-toggle pin 43 moves forward 101 as well. The forward 101 movement of both the knee joint 42 and the trip-toggle pin 43 causes both the trip link 36 and the second toggle link 34 to rotate counterclockwise 112. The counterclockwise rotation 112 of the second toggle link 34 causes the first toggle link 32 to rotate clockwise 111, and the clockwise rotation 111 of the first toggle link 32 causes counterclockwise rotation 112 of the drive shaft 22 and the movable conductor 17, resulting in separation of the movable separable contact 7 from the stationary separable contact 6. As previously stated, the first toggle link 32, the second toggle link 34, and the toggle spring 26 are all configured to ensure that the toggle action of the operating handle 21 remains centered relative to the knee joint 42, so the forward movement of the knee joint 42 and resulting movements of the second toggle link 34 and the first toggle link 32 also cause the operating handle to move from the ON position of FIG. 3A to the TRIP position of FIG. 5. Due to the latch link 37 and the trip link 36 being unlatched when the operating handle 21 is in the TRIP position, pushing the operating handle 21 toward the ON position when the circuit breaker 1 is in the TRIP state will not actuate the operating mechanism 12, such that a user must push the operating handle 21 from the TRIP position to the OFF position in order to manually reset the operating mechanism 12.

Referring now to FIG. 6 (the TRIP FREE state) in addition to FIG. 3A (the ON state) and FIG. 5 (the TRIP state), it is noted that the disclosed improved operating mechanism 12 is advantageously designed such that, even when the operating handle 21 is stuck in the ON position, the operating mechanism 12 is still able to operate in the same manner described above for actuation from the ON state (FIG. 3A) to the TRIP state (FIG. 5). This is apparent when the disposition of the operating mechanism 12 in FIG. 6 (the TRIP FREE state) is compared to the disposition of the operating mechanism 12 in FIG. 5 (the TRIP state), i.e. the disposition of the operating mechanism 12 is the same in both the TRIP and the TRIP FREE states. The sole difference between the TRIP and the TRIP FREE states is that the operating handle 21 is in the ON position instead of the TRIP position in the TRIP FREE state. In order to reset the circuit breaker 1 when it is in the TRIP FREE state, the operating mechanism 12 must be manually reset in order to unlock operating handle 21 so that the operating handle 21 can then be moved to the OFF position. It will be appreciated that the circuit breaker 1 is structured such that the operating mechanism 12 can only be automatically actuated into the TRIP and TRIP FREE states (FIGS. 5 and 6) from the ON state (FIG. 3A) when the link engaging trip lever 38 is actuated to rotate counterclockwise 112 by the trip mechanisms 10 of the pole assemblies 2.

The disclosed improved circuit breaker 1 and its improved operating mechanism 12 offer several advantages against known plug-on miniature circuit breakers, in addition to the previously mentioned reduced part count offered by the four bar linkage design of the disclosed operating mechanism 12 compared to at least one known plug-on miniature circuit breaker having a seven bar linkage. As previously stated, the disclosed circuit breaker 1 and its operating mechanism 12 can be produced for any current rating between 100 amps and 215 amps (100 A to 215 A). One exemplary embodiment of the circuit breaker 1 has a 200 A current rating, and compared to the operating mechanism of at least one other known 200 A two pole plug-on miniature circuit breaker, the disclosed operating mechanism 12 achieves a higher contact force between the separable contacts 6,7 and reduces the operating force required to actuate the operating mechanism 12 between its various states. Higher contact force leads to improved thermal management, due to the decreased electrical resistance at the interface between the separable contacts 6,7. The disclosed improved operating mechanism 12 achieves a contact force of about 18 N between the separable contacts 6,7 and the operating force required to actuate the operating mechanism 12 is 20 N. In contrast, the operating force required to actuate the predecessor plug-on miniature circuit breaker is 110 N.

Furthermore, in the at least one predecessor 200 A two pole plug-on miniature circuit breaker, the contact opening gap is different for the open condition and the trip condition, with the maximum opening distance being 0.64 inch. In contrast, for the disclosed operating mechanism 12, the same contact opening gap is achieved in both the OPEN state and the TRIP state, with the gap being 0.77 inch, i.e. an 18% increase over the 0.64-inch gap of the known circuit breaker. In the predecessor circuit breaker, the lesser contact gap limited arc lengthening and thus led to delayed arc quenching.

In addition, plug-on miniature circuit breakers are known to include calibration screws that can be adjusted in order to adjust the amount of force required to actuate the operating mechanism, and the circuit breaker 1 includes such a calibration screw 50 (numbered in FIGS. 3A-6). However, in the disclosed circuit breaker 1, the calibration screw 50 is located much closer to the front surface of the housing 20 and is thus much more accessible than the calibration screw of other known plug-on miniature circuit breakers.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A circuit breaker, the circuit breaker comprising:
a housing comprising an interior;
a plurality of pole assemblies housed within the housing, each pole assembly comprising:
a stationary conductor comprising a stationary separable contact;
a movable conductor comprising a movable separable contact, the movable conductor being structured to be actuated between a closed state and an open state in order to close and open an electrical connection between a corresponding load and a power source;
a current sensor structured to sense current flowing in the pole assembly; and
a trip mechanism coupled to the trip mechanism of every other pole assembly in the circuit breaker and structured to be actuated by the current sensor when current in the pole assembly exceeds a predetermined threshold;
an operating mechanism housed within the housing and configured to be actuated by the trip mechanism of each pole assembly and operably coupled to the movable conductor of each pole assembly; and
an operating handle operably coupled to the operating mechanism, the operating handle extending between the interior of the housing and an external environment,
wherein the operating mechanism is structured such that, when either of the operating handle or the movable conductor is actuated to rotate in one direction, the other of the movable conductor or the operating handle rotates in another direction opposite the one direction.

2. The circuit breaker of claim 1,
wherein the operating mechanism is structured to be actuated to an OFF state, to an ON state, and to a TRIP state,
wherein the operating handle is structured to be rotated between an OFF position, an ON position, and a TRIP position,
wherein the operating mechanism is structured such that it can only be actuated to the ON state by manual rotation of the operating handle to the ON position,
wherein the operating mechanism is structured such that it can only be actuated to the OFF state by manual rotation of the operating handle to the OFF position, and
wherein the operating mechanism is structured such that it can only be automatically actuated to the TRIP state when any of the trip mechanisms is actuated and such that the operating handle can only be automatically rotated to the TRIP position due to actuation of the operating mechanism to the TRIP state.

3. The circuit breaker of claim 2,
wherein the operating mechanism is structured to be actuated into the TRIP state from the ON state when the operating handle gets stuck in the ON position and current in any of the pole assemblies has reached a fault level threshold, and
wherein the circuit breaker is in a TRIP FREE state when the operating mechanism is in the TRIP state while the operating handle is in the ON state.

4. The circuit breaker of claim 1, further comprising:
a drive shaft operably connecting the movable conductor of each pole assembly to the movable conductor of every other pole assembly,
wherein each pole assembly is positioned laterally relative to every other pole assembly such that all of the pole assemblies are parallel to one another relative to a lateral dimension,
wherein the operating mechanism and the operating handle coincide with exactly one of the pole assemblies relative to the lateral dimension and are disposed laterally relative to all of the other pole assemblies,
wherein the drive shaft is structured such that actuation of the operating mechanism actuates the movable conductors of all of the pole assemblies simultaneously.

5. The circuit breaker of claim 4,
wherein each pole assembly further comprises a drive shaft spring,
wherein each drive shaft spring is positioned within the interior of the drive shaft in a manner that causes the drive shaft spring to exert rearward force on the movable conductor of the corresponding pole assembly, with rearward force being a force that pushes the movable separable contact toward the corresponding stationary separable contact.

6. The circuit breaker of claim 4,
wherein each pole assembly further comprises a line conductor spring,
wherein each line conductor spring is positioned between an interior side of a rear wall of the housing and a rear side of the stationary conductor of the corresponding pole assembly in a manner that causes the line conductor spring to exert forward force on the stationary conductor of the corresponding pole assembly, with forward force being a force that pushes the stationary separable contact toward the corresponding movable separable contact.

7. An operating arrangement for use with a multi-pole circuit breaker, the multi-pole circuit breaker comprising a plurality of pole assemblies, each pole assembly being structured to provide an electrical connection between a corresponding load and a power source and comprising a stationary conductor with a stationary separable contact and a movable conductor with a movable separable contact, each movable conductor being structured to be actuated between a closed state and an open state in order to close and open the corresponding electrical connection, and each pole assembly including a trip mechanism coupled to the trip mechanism of every other pole assembly in the circuit breaker and being structured to be actuated when current in the pole assembly exceeds a predetermined threshold, the operating arrangement comprising:
an operating mechanism configured to be actuated by the trip mechanism of each pole assembly and structured to be operably coupled to the movable conductor of each pole assembly; and
an operating handle operably coupled to the operating mechanism, the operating handle being structured to be manually actuated,
wherein the operating mechanism is structured such that, when either of the operating handle or the movable conductor is actuated to rotate in one direction, the other of the movable conductor or the operating handle rotates in another direction opposite the one direction.

8. The operating arrangement of claim 7,
wherein the operating mechanism is structured to be actuated to an OFF state, to an ON state, and to a TRIP state,
wherein the operating handle is structured to be rotated between an OFF position, an ON position, and a TRIP position,
wherein the operating mechanism is structured such that it can only be actuated to the ON state by manual rotation of the operating handle to the ON position,
wherein the operating mechanism is structured such that it can only be actuated to the OFF state by manual rotation of the operating handle to the OFF position, and
wherein the operating mechanism is structured such that it can only be automatically actuated to the TRIP state when any of the trip mechanisms is actuated and such that the operating handle can only be automatically rotated to the TRIP position due to actuation of the operating mechanism to the TRIP state.

9. The operating arrangement of claim 8,
wherein the operating mechanism is structured to be actuated into the TRIP state from the ON state when the operating handle gets stuck in the ON position and current in any of the pole assemblies has reached a fault level threshold.

10. The operating arrangement of claim 7, further comprising:
wherein the operating mechanism and the operating handle are structured to coincide with exactly one of the pole assemblies relative to a lateral dimension and are structured to be disposed laterally relative to all of the other pole assemblies.
